(19) United States
(12) Patent Application Publication
(10) Pub. No.: US 2009/0144894 A1
(43) Pub. Date: Jun. 11, 2009

(54) Patient adjustment device

(76) Inventor: Karen Shiffert, Auburn, PA (US)

Correspondence Address: HOFFMAN, WASSON & GITLER, P.C., Suite 522, 2461 South Clark Street, Arlington, VA, 22202, US

(21) Appl. No.: 12/314,153

(22) Filed: Dec. 4, 2008

Related U.S. Application Data
(60) Provisional application No. 60/996,751, filed on Dec. 4, 2007.

(51) Int. Cl. A61G 7/10; A61G 7/00

(52) U.S. Cl. 5/81.1 T

(57) ABSTRACT

A patient adjustment device with a plurality of handles placed on the edges of the device to facilitate a patient's movement. In addition to the handles there is provided studs and snaps for additional tethers or items that enable positioning of the patient.

### CROSS-REFERENCES TO RELATED APPLICATIONS

This application claims priority of U.S. provisional patent application Ser. No. 60/996,751, filed Dec. 4, 2007.

### BACKGROUND OF THE INVENTION

The invention generally relates to a patient adjustment device made up of a pad with looped handles that are either permanent or removable. The handles can have adjustable lengths and in addition there can be separate tether devices attached to the device to facilitate movement of a patient in and out of a chair.

Invalid patients generally need assistance to be seated properly into a wheelchair or stationary chair. A caregiver generally stands behind the patient and tries to pull them back into position by grabbing the patient under the arms or by pulling on the patient's clothing. Also draw sheets are used—placed on the wheelchair before seating the patient. All these methods are clumsy for the caregiver, uncomfortable for the patient and may cause injury to both parties. The draw sheet is unattractive, drawing attention to the patient's inability to function on their own, pulling on the arms can cause injury to the patient, and pulling on the clothing causes damage to the clothing.

If the patient is large it is more difficult for the caregiver, having nothing to get a firm hold on to facilitate the seating adjustment. In some cases the patient suffers, left unattended, because of the difficulty of performing the seating adjustment. In these cases where the patient is too heavy for one caregiver to move, the handles being applied two to a side allow the use of a second caregiver to complete an adjustment, one on each side of the patient.

Caregivers are warned however that this device will not make them stronger. If the caregiver is normally able to move the patient by themselves by pulling the clothing or grabbing under the arms, this device will work for them. It will make it easier to accomplish the adjustment with less chance of injury to themselves or the patient.

In the past a number of devices have been made which enable patient's in a bed to be turned or for manipulation purposes. These devices are cumbersome and do not enable the assistor much flexibility in moving the patient in a quick and easy fashion.

It is therefore the principal objective of this invention to provide a safe, convenient means for adjusting the seating position of invalid patients which will not likely incur injuries to the caregiver or the patient.

There is a great deficiency in the prior devices and it is precisely these deficiencies which have been overcome by the adjustment device embodied by the current invention.

### SUMMARY OF THE INVENTION

The invention generally relates to a patient adjustment device for repositioning infirm individuals in their wheelchairs. This easily portable device is made up of a pad sized for the wheelchair and the patient, with permanently secured looped handles. The handles can have adjustable lengths. In addition there can be attached a separate tether strap to keep the device in place while the patient is being seated. The device facilitates movement of a patient into a proper sitting position and helps getting into and out of a wheelchair or stationary chair.

A single caregiver can perform the seating adjustment with less effort than by traditional means of grabbing the patient under their arms or by the seat of the pants and pulling the patient back. This reduces the chance of injury to both herself and the patient. In cases where the patient is too heavy for one caregiver to move, the handles being applied two to a side allow the use of a second caregiver to complete an adjustment, one on each side of the patient.

The patient adjustment device can be made of various fabrics, such as canvas, vinyl, soaker cloth, etc. The pad is sized to fit the various sizes of wheelchairs, making it very portable and unobtrusive in social settings—there is not a lot of superfluous fabric surrounding the patient. Handles are attached to the ends of the pad and are secured thereon by stitching and further by sewing a nylon web to the bottom of the pad, offering additional strength support and covering over the location where the handles are attached to the pad. Handles can also be adjustable and removed if desired, or made very shallow to be hidden when viewed from the top, but still accessible to the caregiver. Snap studs may be installed at the corners to receive a tether strap or other accessories.

This configuration facilitates the unique, portable and efficient device.

### BRIEF DESCRIPTION OF THE DRAWINGS

FIG. 1 displays a top perspective view of the inventive device;

FIG. 2 displays a bottom perspective view of the inventive device, with an exploded view of one underside edge of the device;

FIG. 3 displays an optional tether strap with an exploded view of a snap component for facilitating attachment to the device; and

FIG. 4 displays an alternate embodiment of the tether strap in an adjustable form.

### DETAILED DESCRIPTION OF THE INVENTION

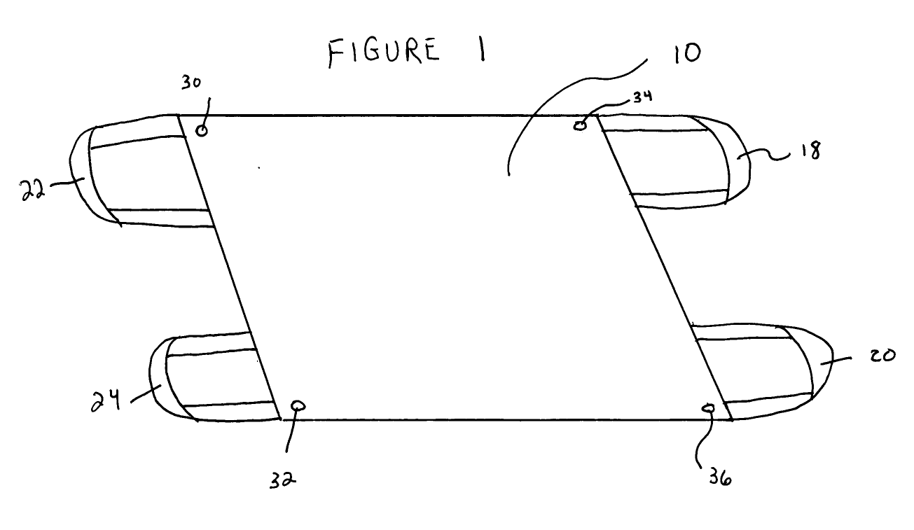

The patient adjustment device 10 as seen in FIG. 1, can be made of washable fabric, such as canvas. The device has a plurality of handles 18, 20, 22 and 24 attached to the device to enable a provider to manipulate the device with a patient seated thereon. Snap studs 30, 32, 34 and 36 are provided at the corner of the device to facilitate attachment of additional tethers and the like.

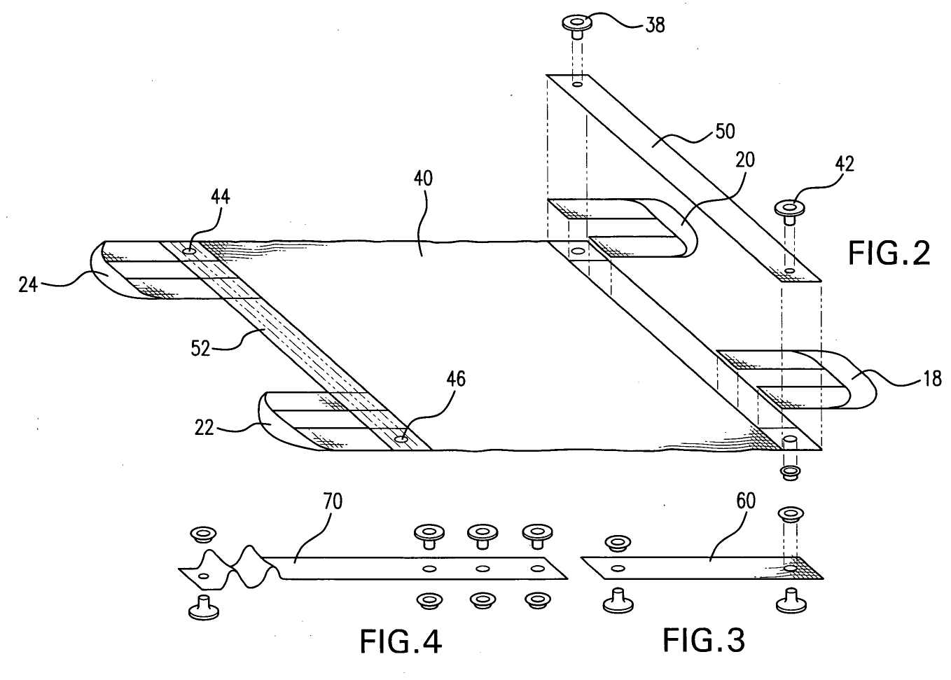

FIG. 2 displays to bottom of the device 40 and illustrates the looped handles 18, 20, 22 and 24 are attached to the bottom of the pad via stitching. A nylon webbing 50 and 52 is sewn onto the bottom of the pad at a first edge and the second edge to securely hold the looped handle 18, 20, 22 and 24 in place. FIG. 2 displays the snap backs 38, 42, 44 and 46 which fit into the snap studs 30, 32, 34 and 36 to facilitate additional components such as tethers and the like.

FIG. 3 illustrates a tether strap that can be attached to the snaps located on the top of the skid seat. Further, FIG. 4 illustrates an adjustable version of the tether which enables for larger lengths to be provided. As illustrated, the tether can have a plurality of snaps to mate with the snap stud on the pad for an adjustable length.

In use, the pad is placed on the seat of a chair, covering approximately the front two-thirds of the seat leaving the back on-third of the seat exposed. The person is placed on the chair in a normal position. A caregiver, standing behind the chair, is able to grab the loop handles and adjust the pad, until the patient's full weight is taken by the pad allowing the patient to be pulled back into the cavity formed at the back of the chair. Such seat or chair can also be a wheeled chair.

The pad may be made in larger sizes to accommodate the size of the chair and the size of the patient. The caregiver repositions the seated person with little discomfort to the patient and facilitates the process for the caregiver.

The pad may be made in a size to cover an entire bed, rather than a chair. In this position, the pad is used to reposition a person in a bed or transfer from one bed to another, such as to a gurney, or to use in a reclining chair. The larger size may necessitate the need for more than four loops to be provided.

It is not beyond the realm of the invention to facilitate various modifications or changes which have been described.

What is claimed is:

1. A patient adjustment device comprising
a pad having an upper side and a lower side; and a first edge and a second edge:
a plurality of looped handles attached to the first edge and to the second edge of the pad; and
a nylon webbing sewn to the first edge and the second edge of the lower side of the pad to secure the looped handles to the pad.

2. The patient adjustment device as claimed in claim 1, further comprising at least one tether for attachment to at least one corner of the pad.

3. The patient adjustment device as claimed in claim 2, further comprising at least one snap for attaching the tether to at least one corner of the pad.

4. The patient adjustment device as claimed in claim 1, wherein two looped handles are attached to the first edge of the pad and two looped handles are attached to the second edge of the pad.

5. The patient adjustment device as claimed in claim 2, wherein the tether has a number of snaps to enable the tether to have an adjustable length.

6. The patient adjustment device as claimed in claim 1, wherein the nylon webbing runs an entire length of the pad along the first edge and second edge of the pad.
